(19) United States
(12) Patent Application Publication
(10) Pub. No.: US 2006/0253336 A1
(43) Pub. Date: Nov. 9, 2006

(54) Data collection system and method

(76) Inventors: Duncan Ta-Te Lin, Taipei (TW); Chih-Pin Wei, Taipei (TW)

Correspondence Address: BIRCH STEWART KOLASCH & BIRCH, PO BOX 747, FALLS CHURCH, VA, 22040-0747, US

(21) Appl. No.: 11/094,297

(22) Filed: Mar. 31, 2005

(51) Int. Cl. G06Q 30/00

(52) U.S. Cl. 705/26

(57) ABSTRACT

A component data collecting system and method applicable to a process of collecting product required component data that comply with approved regulation. The system includes a verifying module, a collecting module, a database, an examining module, a system integrating unit and a management unit. The verifying module verifies the identity of a component supplier. After verification, the component supplier inputs component data through the collecting module and the component data is temporarily stored in a data register. An examining module determines whether the component data comply with the required regulation by comparing it with predetermined examination standard. The component data complying with the regulation is assigned an identification number and stored in a product data section, such that the system integrating unit integrates the component data to related production planning or production operating system, thereby ensuring that components required during product assembly and procurement processes comply with the related standard.

### FIELD OF THE INVENTION

The present invention relates to a data collecting technique, and more particularly, to a component data collecting system and method for collecting component data required for product fabrication and procurement and determining whether the component data comply with approved regulations.

### BACKGROUND OF THE INVENTION

The increase of consumer awareness for better quality of life and safer product along with the increase of environmental awareness have impelled international organizations and countries to establish a series of regulations for imports and exports, such as fire control equipment regulation, power cable regulation, video equipment regulation, electrical material regulation and safety glass regulation and environmental material regulation etc. For example, European countries require manufactures of products sold in the countries to gain approval of related environmental regulations. Consequently, more and more manufacturers have incorporated environmental ideas into the development of their products in order to gain market approval and competitive edge. However, the implementation of complying with regulation system has created problems for manufacturers during the production process, that is, the manufacturers have to determine whether the components required by the products comply with the related regulations before assembly of the products, so as to avoid products being banned from selling when exported to a selling place due to the products not complying with local regulations, which may lead to loss of profit. Therefore, the research and development and/or procurement personnel has to make sure the components approval status before selecting them for assembly to avoid the use of unapproved components and products being banned.

Currently, product manufacturers implement component data collecting process by man. Additionally, related component data and their approval status are not integrated, such that operating personnel are unable to obtain up-to-date information on whether the component data comply with related regulations. Moreover, the component data cannot be easily maintained and updated, thus increasing the workload of personnel, prolonging the production time and reducing production yield. Furthermore, it is easy to make mistakes during procurement of components, since procurement personnel cannot obtain approval status and data about the components being purchased and often accompanied by small differences between the various kinds of components.

Thus, there is an urgent need for a system and method to efficiently collect data and approval status about the components before the production or procurement processes to increase production yield and efficiency and reducing personnel workload and production cost.

### SUMMARY OF THE INVENTION

In light of the forgoing drawbacks, an objective of the present invention is to provide a component data collecting method and system that allows component suppliers to directly provide component data required for production via a network communication unit. The component data is determined and collected by the system to increase component data collecting efficiency.

Another objective of the present invention is to provide a component data collecting system and method that allows component suppliers to update the version of component data via the network to ensure a smooth component data maintenance and update operation.

Still another objective of the present invention is to provide a component data collecting system and method that allows related personnel to inquire the required component data and its approval status before product design, assembly and component procurement, ensuring finished products comply with approved regulation.

Still another objective of the present invention is to provide a component data collecting system and method that allows component data collected and approved by the component data collecting system to be integrated to a production related management system (e.g. a Product Data Management system), so as to plan the production flow in advance and increase production yield.

In accordance with the above objectives, the present invention provides a component data collecting system and method.

The component data collecting system of the present invention comprises: (1) a verifying module for verifying access right of at least one component supplier; (2) a database comprising a data register, an examination data storage section and a product data section, the database for storing related data required during component data collecting process to be acquired by the component data collecting system; (3) a collecting module for collecting component data inputted by the component supplier and storing the collected component data in the data register after the access right of the component supplier is verified by the verifying module; (4)an examining module for examining whether the component data complies with approved regulation by comparing the component data with examination standard stored in the examination data storage section and assigning an identification number to the component data that complies with the approved regulation (6) a management unit for managing operations of and communications between said modules and components during the component data collecting process.

The data collecting method of the present invention collects component data required for product assembly and procurement via a component data collecting system, the method comprises the following steps: (1) verifying access right of at least one component supplier by the system, after verification, collecting component data inputted by the component supplier and storing the component data in a data register of the system; (2) examining by the system whether the component data stored in the data register complies with approved regulation by comparing the component data with predetermined examination standard, if the component data complies with the regulation, going to step (3), else, continuing to examine the next component data; (3) assigning by the system an identification number to the component data that complies with the examination standard, setting the component data as a standard component data and storing the standard component data in a product data section of the system; and (4) integrating the standard component data stored in the product data section to a production related management system by the component data collecting system, thereby increasing production yield and reduction production time.

### BRIEF DESCRIPTION OF THE DRAWINGS

The present invention can be more fully understood by reading the following detailed description of the preferred embodiments, with reference made to the accompanying drawings, wherein:

FIG. 1 is a schematic diagram showing an internal framework of the component data collecting system of the present invention and its connection with component suppliers via a network communication unit; and

FIG. 2 is a flow chart showing implementing procedures of the component data collecting method according to the present invention.

### DETAILED DESCRIPTION OF THE PREFERRED EMBODIMENTS

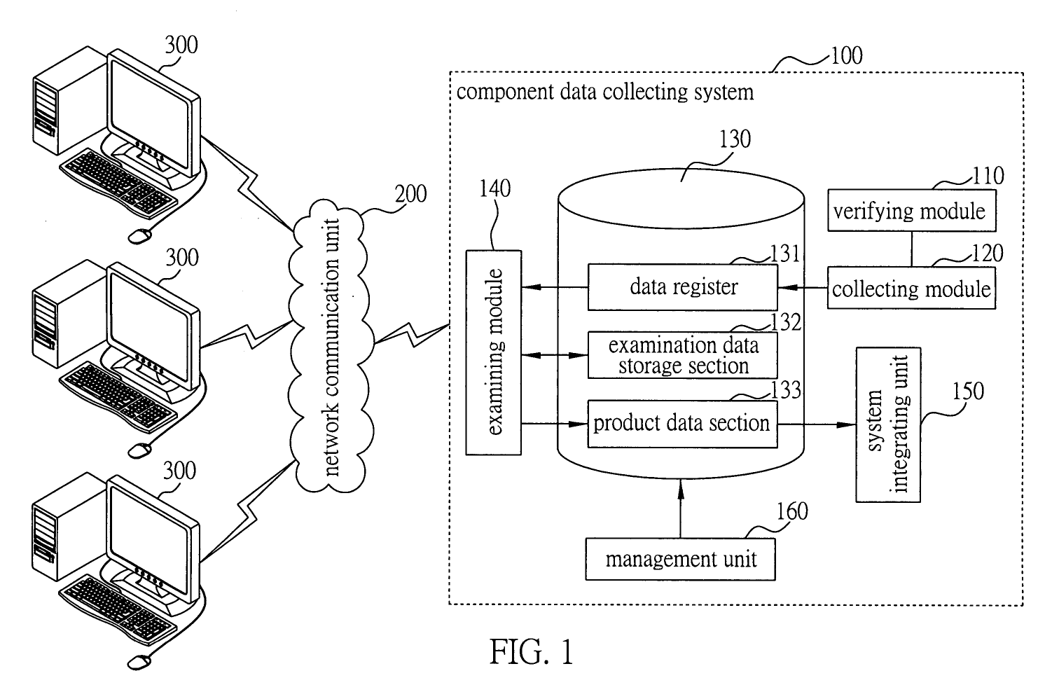

FIG. 1 is a schematic diagram showing an internal framework of the component data collecting system 100 of the present invention and its connection with component suppliers via a network communication unit. As shown, the component data collecting system 100 of the present invention connects to a plurality of component suppliers 300 via a network communication unit 200 for performing component data collecting operations, wherein, the network communication system 200 can be an Internet, an Intranet or an Extranet. The component suppliers 300 can be workstations, PCs or notebook computers for supplying component data to the component data collecting system 100.

The component data collecting system 100 comprises: a verifying module 110, a collecting module 120, a database 130, an examining module 140, a system integrating unit 150 and a management unit 160. The database 130 further comprises a data register 131, an examination data storage section 132 and a product data section 133. In the following embodiments, the data collecting system 100 of the present invention examines whether the collected components conform to environmental regulations. However, it is noted that this application is used only to illustrate one embodiment of the present invention, the present invention is not limited to this application but can be applied to the examination of other types of regulations, such as fire control equipment regulation, power cable regulation, video equipment regulation, electrical material regulation and safety glass regulation etc.

The verification module 110 is used to verify the identity of the component supplier 300 who wishes to upload component data (e.g. environmental deed, Material Safety Data Sheets (MSDS) and testing reports) to the component data collecting system 100 via the network communication unit 200. After the verification is successful, the component data collecting system 100 then grants access to the component supplier 300.

After the component supplier 300 has been granted access by the verification module 110, the collecting module 120 reads component data uploaded by the component supplier 300 and integrates it for centralized storage.

The database 130 is used to store related data required by the component data collecting system 100 during data collecting process, including component data integrated by the collecting module 120 (stored in the data register 131), standard examination data for reference when performing examination on the collected data by the component data system (stored in the examination data storage section 132) and standard component data that has passed the examination (stored in the product data section 133).

The examining module 140 is used for examining the component data provided by the component supplier 300 to determine whether it conforms to the required regulations. The examining module 140 reads the previously stored standard examination data of the environmental regulations and compares it with the component data stored in the data register 131 in order to determine whether the component data is in compliance with the required environmental regulations. If the examination is passed, the component data is assigned an identification number, converted into a text file and defined as a standard component data. Thereafter, the standard component data is then stored in the product data section 133.

The system integrating unit 150 integrates the standard component data stored in the product data section 133 to a production management system (not shown), such as a Product Data Management (PDM) system, ensuring that products assembled comply with the environmental regulation.

The management unit 160 is used to monitor and manage the operations and signal communications between the above units and modules to ensure smooth component data collecting process.

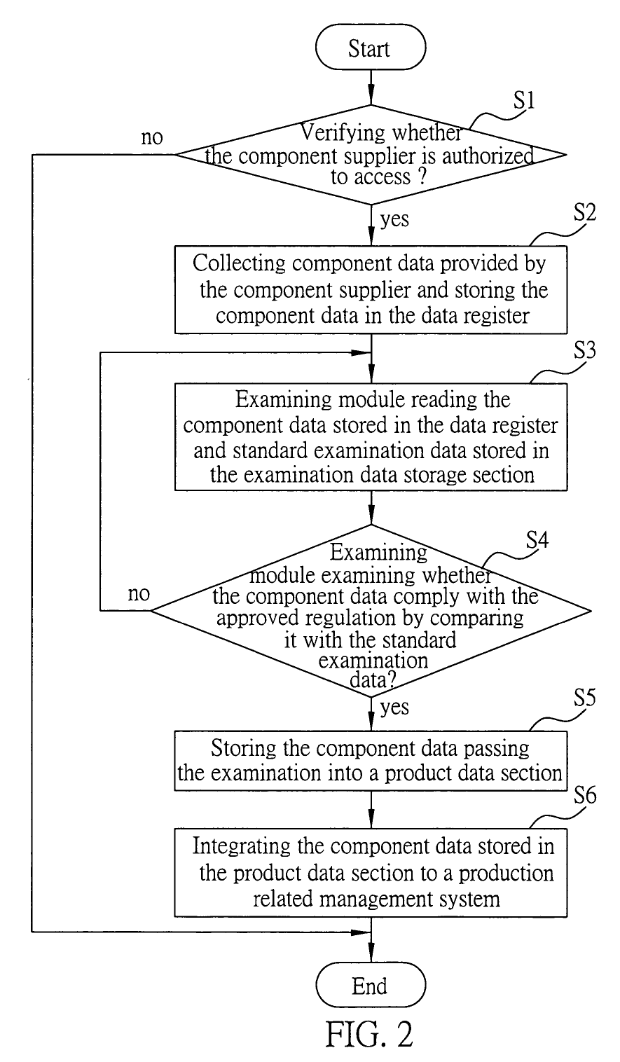

FIG. 2 is a flow chart showing implementing procedures of the component data collecting method according to the present invention. The method is used to allow component suppliers to provide component data to a component data collecting system via a network communication unit, such that the system examines to see if the component data comply with approved regulations. The following implementing procedure is described in conjunction with the block diagrams of FIG. 1. As shown in FIG. 2, in step S1, when a component supplier 300 wishes to login to the component data collecting system 100 via the network communication unit 200, the user identity of the component supplier 300 is verified by the verifying module 110, if the component supplier 300 has right to access, then continues to step S2, else, ends the component data collecting method.

In step S2, component data ((e.g. environmental deed, Material Safety Data Sheets (MSDS) and testing reports) are read and integrated by the collecting module 120, and the collected component data are then stored in the data register 131 for use by subsequent processes, then goes to step S3.

In step S3, the component data stored in the data register 131 and the standard examination data stored in the examination data storage section 132 are read by the examining module 140, then proceeds to step S4.

In step S4, the read component data are examined by the examining module 140 to determine whether the component data provided by the component supplier 300 comply with the approved standard data from the examination data storage section. If so, then goes to step S5, else, returns to step S3 to read the next component data.

In step S5, an identification number is assigned by the examining module 140 to the component data that passed the examination, and the component data is converted into a text file and stored in the product data section 133 as standard component data to facilitate searching of the required component data by product assembly, design, and component procurement personnel, then proceeds to step S6.

In step S6, the standard component data stored in the product data section 133 are then integrated by the system integrating unit 150 to a production management system (not shown), such as a Product Data Management (PDM) system, ensuring that products assembled comply with the environmental regulation, reducing production time, and reducing the risks of products being rejected for failing to comply with approved regulations.

In summary, the component data collecting system and method of the present invention have the following features. Component data collection is performed via the network communication unit by the component data collecting system, such that related personnel workload can be easily simplified, which also facilitates maintenance and update of the component data, thereby improving work efficiency. Further, component data collected can be easily referenced by the related personnel, such that the component data of the required components can be quickly obtained, thereby increasing production flexibility and reducing production time. Moreover, the procurement personnel can easily obtain data related to components to be purchased, such as component specification and features etc., it ensures that components complied with the required regulations are purchased, thus improving procurement efficiency. Additionally, component data collected are integrated to the production management system to ensure that developed new products conform to the approved regulations.

It should be apparent to those skilled in the art that the above description is only illustration of specific embodiments and examples of the present invention. The present invention should therefore cover various modifications and variations made to the herein-described structure and operations of the present invention. Therefore, the scope of the present invention should be defined only by the following appended claims.

What is claimed is:

1. A component data collecting system, comprising:
a verifying module for verifying access right of at least one component supplier;
a database for storing related data required during collection of component data to be acquired by the component data collecting system;
a collecting module for collecting component data inputted by the component supplier and storing the collected component data in the database after the access right of the component supplier is verified by the verifying module;
an examining module for examining whether the component data comply with approved regulation by comparing the component data with examination standard stored in the database, and for assigning an identification number to the component data that comply with the approved regulation and setting the component data as standard component data;
a system integrating unit for integrating the standard component data to a production management system to ensure that the component data required for production all comply with the approved regulation; and
a management unit for managing operations of and communications between the preceding modules/unit during the collection of component data.

2. The component data collecting system as claimed in claim 1, wherein the component data collecting system is applicable in a network communication unit.

3. The component data collecting system as claimed in claim 2, wherein the network communication unit is connected to the at least one component supplier and the component data collecting system.

4. The component data collecting system as claimed in claim 2, wherein the network communication unit is one selected from the group consisting of Internet, Intranet and Extranet.

5. The component data collecting system as claimed in claim 1, wherein the at least one component supplier is at least one selected from the group consisting of a workstation, a personal computer and a laptop computer.

6. The component data collecting system as claimed in claim 1, wherein the database further comprises a data register, an examination data storage section and a product data section.

7. The component data collecting system as claimed in claim 1, wherein the production management system is a Product Data Management (PDM) system.

8. A component data collecting method for collecting component data required for product assembly and component procurement via a component data collecting system, the component data collecting method comprising the steps of:
(1) verifying access right of at least one component supplier via the component data collecting system, and after verification, collecting component data inputted by the component supplier and storing the component data in a data register of the component data collecting system;
(2) examining via the component data collecting system whether the component data stored in the data register comply with approved regulation by comparing the component data with predetermined examination standard, if the component data comply with the approved regulation, going to step (3), or else, continuing to examine a next record of component data;
(3) assigning via the component data collecting system an identification number to the component data that comply with the examination standard, and setting the component data as standard component data and storing the standard component data in a product data section of the component data collecting system; and
(4) integrating the standard component data stored in the product data section to a production management system via the component data collecting system.

9. The component data collecting method as claimed in claim 8, wherein the component data collecting system is applicable in a network communication unit.

10. The component data collecting method as claimed in claim 9, wherein the network communication unit is connected to the at least one component supplier and the component data collecting system.

11. The component data collecting method as claimed in claim 9, wherein the network communication unit is one selected from the group consisting of Internet, Intranet and Extranet.

12. The component data collecting method as claimed in claim 8, wherein the at least one component supplier is at least one selected from the group consisting of a workstation, a personal computer and a laptop computer.

13. The component data collecting method as claimed in claim 8, wherein the production management system is a Product Data Management (PDM) system.
